(19) United States
(12) Patent Application Publication
(10) Pub. No.: US 2009/0008947 A1
(43) Pub. Date: Jan. 8, 2009

(54) Slide Latch

(76) Inventors: Hsiang-Chi Chien, Shulin City (TW); Wei-Chen Kao, Shulin City (TW)

Correspondence Address: Kamrath & Associates, P.A., Suite 245, 4825 Olson Memorial Highway, Golden Valley, MN, 55422, US

(21) Appl. No.: 11/774,020

(22) Filed: Jul. 6, 2007

(51) Int. Cl. E05C 1/08

(52) U.S. Cl. 292/163

(57) ABSTRACT

The present invention relates to a slide latch for electronic devices to slide the cover open or closed relative to the base of the electronic device and has a base, a sliding latch, a spring and a rotating latch. The base has two longitudinal sides formed parallelly on and protruding from the base. Two turning protrusions are formed parallelly on and protruding from the two longitudinal sides and each has a guide edge, an inclined edge and an apex. A sliding latch is mounted slidably on the base. A spring is mounted on the base, which abuts the sliding latch. A rotating latch is mounted rotatably on the sliding latch, between the two guide edges of the two turning protrusions of the base. The present invention allows the cover to open or close relative to the base without mounting hinges on the electronic device.

### BACKGROUND OF THE INVENTION

1. Field of the Invention

The present invention relates to a slide latch, especially to a slide latch mounted in electronic devices. The slide latch is used to slide a cover open or closed relative to a base of the electronic device.

2. Description of the Related Art

Electronic devices have a cover mounted to a base. Some small electronic devices, for example cell phones or personal digital assistants further comprise a screen acting as the cover and a keypad on the base. In order to reduce a length of the electronic device, the cover is mounted above the base. A hinge is usually mounted between the cover and the base to allow someone to pivotally open or close the cover. Therefore, another method to move the cover relative to the base of the electronic device without a conventional hinge is necessary.

### SUMMARY OF THE INVENTION

The objective of the present invention is to provide a slide latch for electronic devices to slide a cover open or closed relative to a base of the electronic device.

To achieve the objective, a slide latch comprises a base, a sliding latch, a spring and a rotating latch. The base has two longitudinal sides formed parallelly on and protruding from the base. Two turning protrusions are formed parallelly on and protruding from the two longitudinal sides and each has a guide edge, an inclined edge and an apex. A sliding latch is mounted slidably on the base. A spring is mounted on the base, which abuts the sliding latch. A rotating latch is mounted rotatably on the sliding latch, between the two guide edges of the two turning protrusions of the base. The present invention allows the cover to open or close relative to the base without mounting hinges on the electronic device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the slide latch in accordance with the present invention;

FIG. 2 is an exploded perspective view of the slide latch in FIG. 1;

FIG. 3 is a front view of the slide latch in FIG. 1;

FIG. 4 is a front view of a sliding latch and a rotating latch of the slide latch in FIG. 1;

FIG. 5 is an operational front view of the slide latch in FIG. 1;

FIG. 6 is an operational side view of a slide opening electronic device with the slide latch in FIG. 1 mounted inside;

FIG. 7 is an operational side view of the slide latch in FIG. 1, showing the rotating latch rotating;

FIG. 8 is an operational side view of the slide opening electronic device in FIG. 6, showing the cover opening;

FIG. 9 is an operational front view of the slide latch in FIG. 1, showing the sliding latch sliding open;

FIG. 10 is an operational front view of the slide latch in FIG. 1, showing the slide latch opened;

FIG. 11 is an operational side view of the slide opening electronic device in FIG. 6, showing the slide opening electronic device opened;

FIG. 12 is an operational side view of the slide latch in FIG. 1, showing the slide latch being closed; and

FIG. 13 is an operational side view of the slide opening electronic device in FIG. 6, showing the slide opening electronic device closing.

### DETAILED DESCRIPTION OF THE PREFERRED EMBODIMENTS

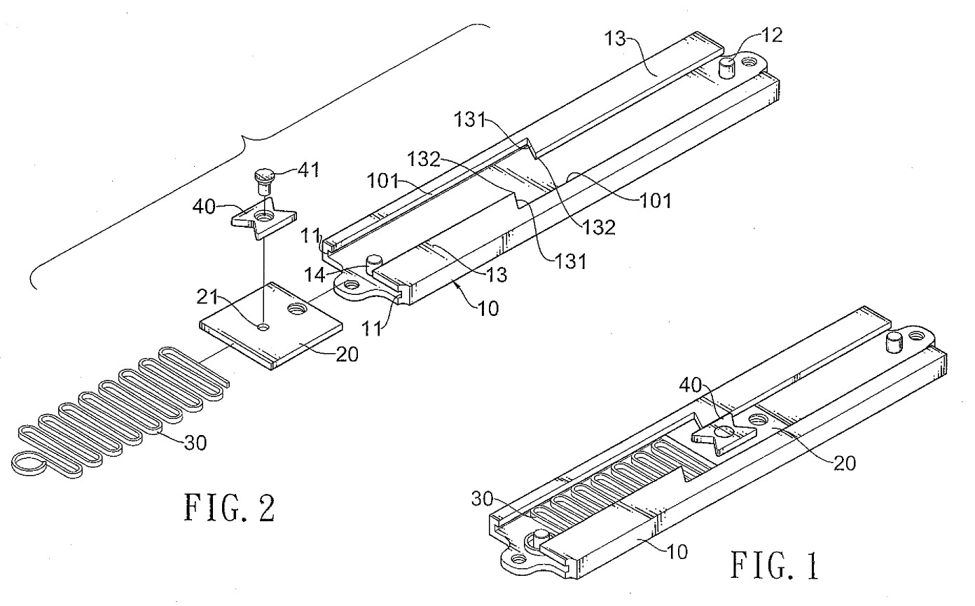

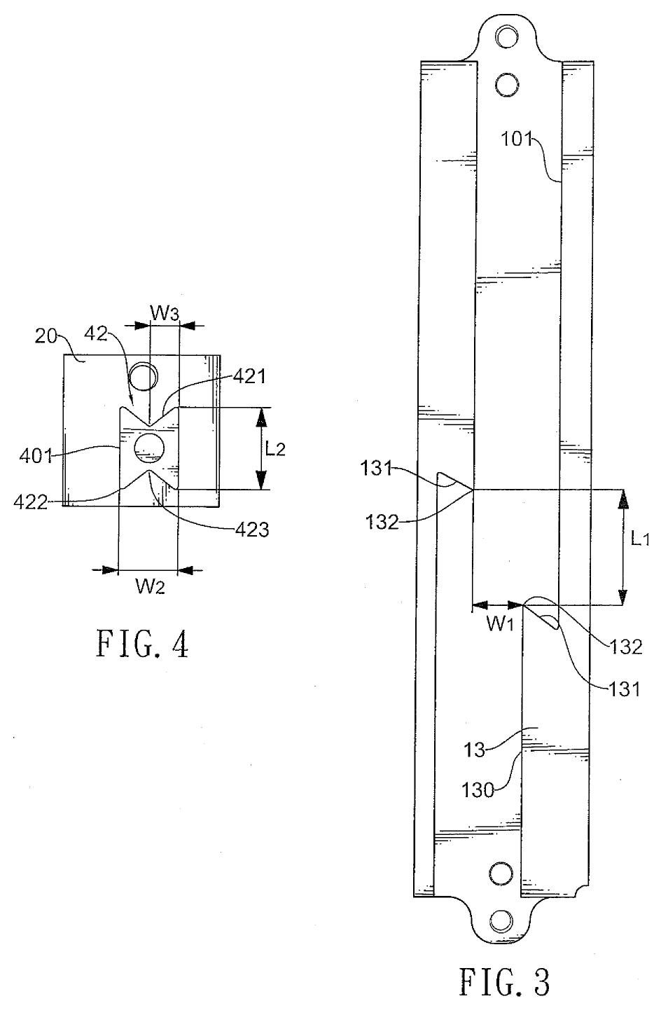

With reference to FIGS. 1 to 4, the slide latch in accordance with the present invention comprises a base (10), a sliding latch (20), a spring (30) and a rotating latch (40).

The base (10) has two ends, two edges, two longitudinal sides (101), two turning protrusions (13) and may have a spring mount (14), a positive stop (12) and two slide tracks (11).

The longitudinal sides (101) are formed parallelly on and protrude respectively from the edges of the base (10) and each has a bottom and a top.

The turning protrusions (13) are formed parallelly on and protrude respectively from the top of the two longitudinal sides (101) and each comprises a guide edge (130), an inclined edge (131) and an apex (132).

The guide edge (130) of the turning protrusion (13) protrudes a distance from the longitudinal side (101) of the base (10) and is separated from the other guide edge (130) by a transverse distance (W₁). The guide edge (130) of the turning protrusions (13) may be parallel to the longitudinal side (101).

The inclined edge (131) is respectively formed at two acute angles respectively from the longitudinal side (101) and the guide edge (130). The two acute angles between the inclined edge and the longitudinal side and the guide edge may be equal to each other.

The apex (132) is formed between the guide edge (130) and the inclined edge (131) and is separated from the other apex (132) by a longitudinal distance (L₁).

The spring mount (14) is formed and protrudes from one end of the base (10). The positive stop (12) is formed on and protrudes from the end of the base (10) opposite to the spring mount (14).

The slide tracks (11) are formed respectively at the bottom of the longitudinal sides (101) of the base (10) and opposite to each other.

The sliding latch (20) is mounted slidably on the base (10) and has at least two edges. The at least two edges of the sliding latch (20) respectively slide in the slide tracks (11). The sliding latch (20) may have a through hole (21) formed through the sliding latch (20).

The spring (30) is mounted on the base (10) and has two ends respectively connected to the spring mount (14) and abutting the sliding latch (20) to push the sliding latch (20) away from the spring mount (14).

The rotating latch (40) is mounted rotatably on the sliding latch (20), between the two guide edges (130) of the two turning protrusions (13) of the base (10), may slide between the spring mount (14) and the positive stop (12), has a center, two outer edges (401), four inner edges (421), four corners (422), two inflections (423) and may have a pintle (41),

The outer edges (401) of the rotating latch (40) are defined parallelly opposite to each other, separated by a width (W₂), and have an equal length (L₂). When compared to the separation between the apexes (132) and the guide edges (130), L₂ is less than L₁ and L₂ is greater than W₁.

The inner edges (42) are recessed in pairs from the rotating latch (40) to form a V-shape between the two outer edges to form the inflections (423).

An inflection axis is defined adjoining and extending through the inflections (423).

A distance W₃ is defined perpendicularly between the inflection axis and the adjacent corner (421).

When compared to the separations of the guide edges (132) of the base, L₂ is greater than W₃ and W₂ is greater than W₁ that is in turn greater than W₃.

The pintle (41) is mounted through the center of the rotating latch (40) and the through hole (21) of the sliding latch (20).

The center of the rotating latch (40) is closer to one of the edges of the sliding latch (20) and farther than the other edge of the sliding latch (20).

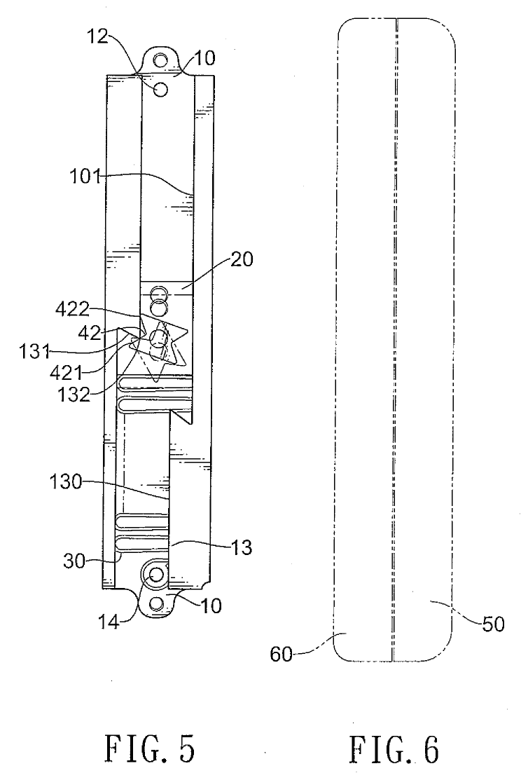

With further reference to FIGS. 5 and 6, the slid latch in accordance with the present invention is mounted inside an electronic device to allow the cover (50) to slide relative to the base (60). When the cover (50) is closed on top of the base (60), the spring (30) is compressed by the sliding latch (20), the inner edge (42) of the rotating latch (40) nearest to the inclined edge (131) further from the spring mount (14) abuts the same inclined edge (131) with the apex (132) of the turning protrusion (13) abutting the inflection (423) of the rotating latch (40). Therefore, the rotating latch (40) is held by the turning protrusion (13) and the spring (30) pushes against the sliding latch (20) to hold the electronic device closed.

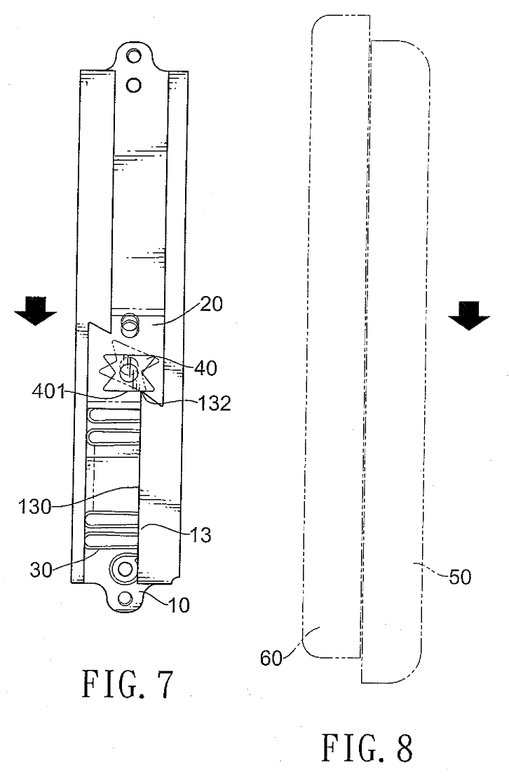

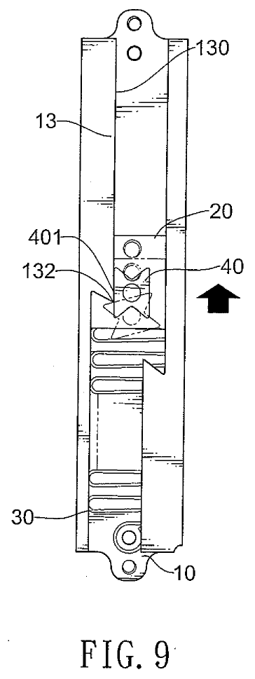

With further reference to FIGS. 7 and 8, when a person wants to use the electronic device, the cover (50) of the electronic device is moved, causing the sliding latch (20) to slide away from the turning protrusion (13) until the rotating latch (40) abuts the apex (132) of the turning protrusion (13) closer to the spring mount (14). The apex abuts the outer edge (401) of the rotating protrusion causing the rotating protrusion (40) to rotate until the outer edge (401) corresponds to the inclined edge (131) of the turning protrusion (13) further from the spring mount (14).

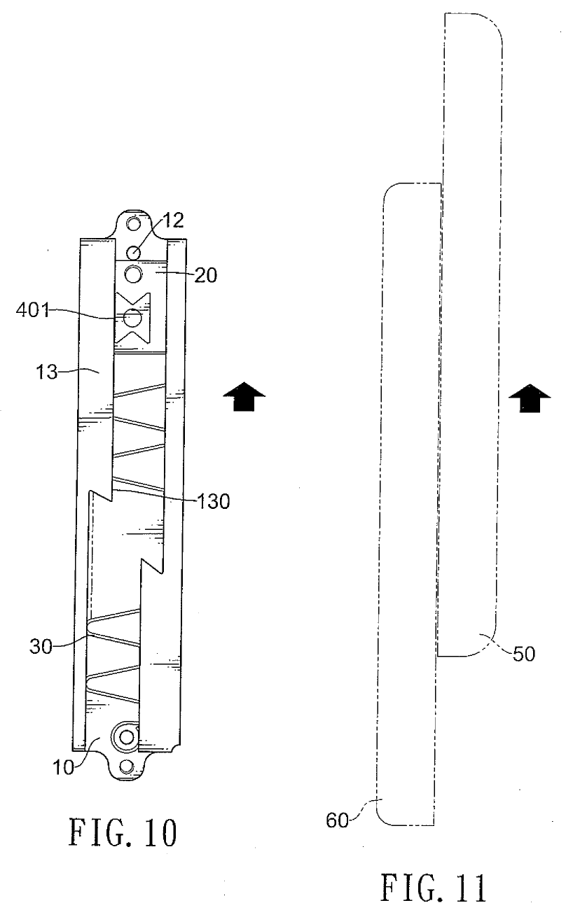

With further reference to FIGS. 9, 10 and 11, in this orientation, the spring (30) pushes the sliding latch (20) away from the spring mount (14), the outer edge (401) of the rotating latch abuts the apex (132) of the turning protrusion (13) further from the spring mount (14) causing the rotating latch (40) to rotate until the outer edge (401) is parallel with the guide edge (130), allowing the sliding latch (20) to pass the turning protrusions (13) until stopped by the positive stop (12) and the cover (50) is open.

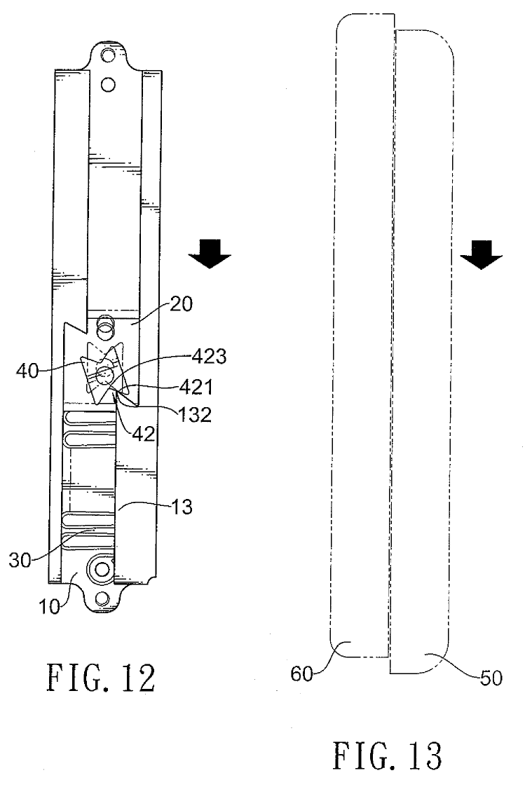

With further reference to FIGS. 12 to 13, when a person wants to close the cover (50), the cover (50) is slid so that the sliding latch (20) slides towards the spring mount (14). The inner edge (42) of the rotating latch (40) abuts the apex (132) of the turning protrusion (13) closer to the spring mount (14) causing the inner edge (421) of the rotating latch to align parallelly with the inclined edge (132) of the same turning protrusion (13).

The spring (30) pushes the sliding latch (20) away from the spring mount (14) so the inner edge (42) of the rotating latch (40) abuts and is held by the inclined edge (131) of the turning protrusion (13) further from the spring mount (14). The upper cover (50) of the electronic device is closed to the base (60).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A slide latch, comprising:
a base having
two ends;
two edges;
two longitudinal sides being formed parallelly on and protruding respectively from the edges of the base and each longitudinal side having a bottom and a top; and
two turning protrusions being formed parallelly on and protruding respectively from the top of the longitudinal sides and each turning protrusion having
a guide edge of the turning protrusions protruding a distance from the longitudinal side of the base and being separated from the other guide edge by a transverse distance W₁;
an inclined edge being respectively formed at two acute angles respectively from the longitudinal side and the guide edge; and
an apex being formed between the guide edge and the inclined edge and being separated from the other apex by a longitudinal distance L₁;
a sliding latch being mounted slidably on the base and having at least two edges;
a spring being mounted on the base and having two ends, one end of the spring abutting the sliding latch; and
a rotating latch being mounted rotatably on the sliding latch, between the two guide edges of the two turning protrusions of the base and having
a center;
two outer edges;
four inner edges;
four corners; and
two inflections.

2. The slide latch as claimed in claim 1, wherein the outer edges of the rotating latch are defined parallelly opposite to each other and being further separated by a width W₂, and having an equal length L₂ that is less than L₁ and greater than W₁,
the four inner edges are further recessed in pairs from the rotating latch to form a V-shape between two different outer edges to form the two inflections;
an inflection axis is defined adjoining and extending through the two inflections; and
a distance W₃ is defined perpendicularly between the inflection axis and the adjacent corner, which is less than L₂ and is less than W₁ that is less than W₂.

3. The slide latch as claimed in claim 2, wherein the center of the rotating latch is closer to one of the edges of the sliding latch and farther than the other edge of the at lest two edges of the slide latch.

4. The slide latch as claimed in claim 2, wherein the guide edge of the turning protrusions is parallel to the longitudinal side, the two acute angles between the inclined edge and the longitudinal side and the guide edge are equal to each other.

5. The slide latch as claimed in claim 3, wherein the guide edge of the turning protrusions is parallel to the longitudinal side, the two acute angles between the inclined edge and the longitudinal side and the guide edge are equal to each other.

6. The slide latch as claimed in claim 4, wherein the two slide tracks are formed respectively at the bottom of the longitudinal sides of the base and opposite to each other; and
the edges of the sliding latch respectively slide in the two slide tracks.

7. The slide latch as claimed in claim 5, wherein the two slide tracks are formed respectively at the bottom of the longitudinal sides of the base and opposite to each other; and
the edges of the slides latch respectively slide in the two slide tracks.

8. The slide latch as claimed in claim 6, wherein the one end of the base further comprises:
a spring mount being connected to one end of the spring and formed on and protruding from one end of the base; and
a positive stop being formed on and protruding from the end opposite to the spring mount.

9. The slide latch as claimed in claim 7, wherein the one end of the base further comprises:
a spring mount being connected to one end of the spring and formed on and protruding from one end of the base; and
a positive stop being formed on and protruding from the end opposite to the spring mount.

10. The slide latch as claimed in claim 8, wherein the sliding latch further comprises a through hole formed through the sliding latch; and
the rotating latch further comprises a pintle mounted through the center of the rotating latch and through the through hole of the sliding latch.

11. The slide latch as claimed in claim 9, wherein the sliding latch further comprises a through hole formed through the sliding latch; and
the rotating latch further comprises a pintle mounted through the center of the rotating latch and through the through hole of the sliding latch.
